(19) United States
(12) Patent Application Publication
(10) Pub. No.: US 2005/0027583 A1
(43) Pub. Date: Feb. 3, 2005

(54) Programmable automated trustee (PAT) system, capable of advanced oversight applications, through the tracking, monitoring and analyzing of the investment process workflow activities, identifying anomalies and trends and reporting such anomalies and trends to the user

(76) Inventors: Colin Julian Smit, Cape Town (ZA); Johannes Conradie Bruce, Somerset (ZA)

Correspondence Address: INVESTMENT TRANSACTION ANALYSIS, INC;CHRISTIAN H. BENT, 1000 TUDOR DRIVE, CROWNSVILLE, MD, 21032, US

(21) Appl. No.: 10/629,689

(22) Filed: Jul. 30, 2003

(51) Int. Cl. G06F 17/60

(52) U.S. Cl. 705/9; 705/10

(57) ABSTRACT

The invention utilizes a computer apparatus to automatically track and monitor the activities of role players in the investment process analyzing and detecting anomalies, variances and transgressions. The system automatically generates immediate E-mail or SMS alerts in certain instances or generates displays or reports quantifying costs or benefits of transactions, at predetermined intervals. These reports will contain relative performance measurement of asset management service providers, brokers or other investment entities with respect to compliance with regulations, a set of behavioral mandates and any other benchmark or parameter as requested by the client.

### BACKGROUND

### FIELD OF THE INVENTION

The field of this invention pertains to the automated monitoring of compliance and the oversight of individuals and/or organisations involved in the buying and selling of financial instruments and the making of investment decisions with specific client investment mandates and involves, among other elements, the analysis and reporting of best trade execution analysis and draws from a perceived need to provide answers to the following question: Does the appointment of a Fund Manager guarantee the benchmark investment performance and/or that a portfolio is efficiently managed and/or that the entire investment process is managed effectively and efficiently?

### BRIEF SUMMARY OF THE INVENTION

The invention utilizes a computer apparatus to automatically track and monitor the activities of role players in the investment process analyzing and detecting anomalies, variances and transgressions. The system automatically generates immediate E-mail or SMS alerts in certain instances or generates displays or reports quantifying costs or benefits of transactions, at predetermined intervals. These reports will contain relative performance measurement of asset management service providers, brokers or other investment entities with respect to compliance with regulations, a set of behavioral mandates and any other benchmark or parameter as requested by the client.

The invention utilizes a computer apparatus to automatically generate ongoing real-time and periodic comparative and relative data displays or reports, including exception reports containing customized analyses of the trading and investment activities of individuals or machines involved in the buying, selling and management of financial instruments (hereinafter referred to as the investment process) while entrusted with following specific investment mandates of clients. The invention automates identification of variances that produce alterations in expected investment returns. The invention enables detailed real time and historical analyses of buying, selling and management activities with regard to financial instruments over time to determine whether or not these activities can be shown to be in best interests of a particular investment fund. A report could be provided to show the points in the investment process or trading activities of these individuals that result in changes in expected trading behavior that may translate into alterations in fund investment returns and the report may also quantify the costs incurred as a result of such behavior. Reports may represent data in one-dimensional, two dimensional or multi-dimensional formats. Reports may use intelligent multidimensional icons to represent causes for variations in total performance of an investment manager/s. The invention enables intelligent aggregation and/or averaging of performance elements of securities in ways that provide an oversight input for specific advisories to change the behavior of traders and fund managers working on behalf of a specific client.

One exemplary embodiment of the invention will be a report module that highlights each “anomaly” against predetermined tolerance limits and at the same time calculates the respective cost to the Fund. The oversight function of the invention empowers a client with factual data on which to make informed decisions concerning the service provided by their Fund Managers, and the traders and stockbrokers used by them. This module will identify trading patterns whether good or bad and provide objective benchmarks against which to evaluate portfolio managers, and the stockbrokers that they utilize. The system is programmable to automatically report anomalies by initiating E-mail or SMS alerts without human intervention. Clients may include regulators, institutional and pension fund overseers, trustees or any individual or entity with the need to evaluate, monitor and understand the activities of individuals involved in the buying, selling and management of financial instruments on their behalf. Financial instruments include, but are not limited to, stocks, bonds, certificates of deposit (CD's), cash, futures and options and any other derivatives.

### BRIEF DESCRIPTION OF THE DRAWINGS

The Invention can be summarized in five figures (FIG. 1, FIG. 2, FIG. 3, FIG. 4, FIG. 5), which explain the schematic working of the system:

FIG. 1 is a schematic flowchart depicting the process by which the five core databases interact to store, process and share information captured within the computer apparatus;

FIG. 2 is a schematic flowchart depicting the process by which the information subsets are optionally input and stored in the computer apparatus;

FIG. 3 shows a sample two-dimensional graph report;

FIG. 4 shows the interrelationships between the Workflow database and the Participants database;

FIG. 5 is a schematic overview of how the system is accessible to individual users via an Intranet, Internet, World Wide Web, Local area network, and Wide area network; and

FIG. 6 is a schematic overview of how the different investment service providers inter-relate in the investment process.

### DETAILED DESCRIPTION OF THE ILLUSTRATED EMBODIMENTS

The invention enables unprecedented oversight into the efficiency and cost effectiveness of trader and investment fund manager behavior by tracking his/her actions at every key step in the process of portfolio management. The invention enables direct dissection and determination of the direct and indirect costs of executing investment ideas, a process that can be referred to as Best Executions Analysis (BEA).

For the purposes of describing this process the principal hereunder is defined as that individual or entity that directly executes a buy, sell or hold order with regard to a particular financial instrument or group of instruments.

The invention automates the monitoring, analysis and evaluation of a wide variety of steps in the process of investment in financial instruments that have not hitherto been subject to systematic scrutiny. This involves the recording of:

1. Time and date of identification and validation of investment instruments that fit the mandated criteria of the client.

2. Time and date of selection by the fund manager of a specific principal to execute a trade in said financial instrument/s.

3. Time and date and target price of order placed by that specific principal for trade of said financial instrument/s.

4. Time, date and price of order completion or lack thereof, with reasons for same.

5. Time, date and market price of buying and selling activities for the same securities that a particular broker was engaged in buy, sell or hold activities for.

6. Calculation of variances in behavior between the principal and the market including pricing, timing or buying and selling, sale or non sale, sale or purchase by principal or fund manager or brokerage house or other funds of same stock and prices of these transactions.

7. Calculation of the value added/or cost of specific buying and selling decisions over periodic intervals.

Best Execution Analysis is the continuous monitoring and evaluation of the efficiency of the processes required to turn an investment idea into an executed transaction. BEA enables the overseer or trustee/s of an investment fund to have a powerful tool for the measurement and control of trading costs in a much broader sense than before , because brokerage is just one element of the costs incurred by brokers acting on their behalf as well as the evaluation of these service providers. The invention is a powerful tool for the quantification of all costs involved in buying, selling, decision-making and timing of activities incurred by all role players in the investment process. These include but are not limited to:

1. delays in placement of buy or sell orders for financial instruments;

2. buying and selling of financial instruments for principal—tracking the volume and timing of such activities in comparison with volume and timing of buying and selling for client; and

3. Volume and timing of strategic acquisitions of financial instruments versus sales to clients and principal.

The process entails a computer program that enables sequential documentation and tracking of the times and events in the process whereby investments ideas are acted upon and transformed into implemented actions for a designated portfolio.

The invention is predicated upon the idea that: (a) the intensity of the “Active Monitoring and Analysis” (A.M. & A) processes, implemented and maintained by Institutional fund overseers and/or Trustees, can have a fundamental impact on investment performance, and; (b) the failure of Overseers and/or Trustees to carry out their fiduciary responsibilities is often the result of being provided with too much unprocessed information too late; (c ) regulators up until now did not have the equipment or manpower to monitor and analyze every transaction in the investment process for compliance and efficiency.

The invention provides Fund Overseers and/or Trustees, with concise summaries of unbiased accurately analysed and interpreted process-derived intelligence, enabling them to make timely, well-reasoned decisions, and in so doing, ensure optimum benefit for their portfolios while carrying out their fiduciary responsibilities to their members.

One exemplary embodiment of the invention is a trading oversight service. In the trading oversight service, the invention enables direct comparison of trading activities of each bond and each equity in a designated portfolio against an appropriate benchmark. Take the example of a Fund that mandates that asset managers maintain assets that meet designated specific criteria such as, that buy and sell prices are within specified tolerance limits, asset mix, prohibited investments or minimum market capitalization, maximum or minimum individual and/or sectoral weightings within the portfolio. The invention will track the trading of such stocks to ascertain whether or not they were purchased at the most opportune time and price and that the volumes reflected the mandates of the Fund Overseer or Trustees. Bond and money-market activities and other mandate adherence may be subjected to similar scrutiny. This process identifies and quantifies excessive costs incurred by the Fund, due to inefficiencies and or failure to adhere to best efforts and practice procedures. The result of the findings can be represented in real-time and/or batched and/or exception reports (with agreed upon tolerance levels) delivered in electronic or paper medium formatted to provide summary or exploded views of exceptional activities that have occurred within the portfolio.

One exemplary embodiment of the invention will be a report module that highlights each “anomaly” against predetermined tolerance limits and at the same time calculates the respective cost to the Fund. The oversight service empowers the Trustees with factual data on which to make informed decisions concerning the service provided by their Fund Managers, and the traders and stockbrokers used by them. This module will identify trading patterns whether good or bad and provide objective benchmarks against which to evaluate portfolio managers, and the stockbrokers that they utilize.

Another embodiment of the invention will include a report that can be presented in a variety of permutations allowing Trustees to see activities across all portfolios, or by portfolio managers, or by broker or by share. This module is specifically designed to protect Trustees by providing them with visible proof of compliance. The system is programmable to alert the user to any predetermined anomaly, variance or transgression detected in the investment process , without human intervention via E-mail or SMS.

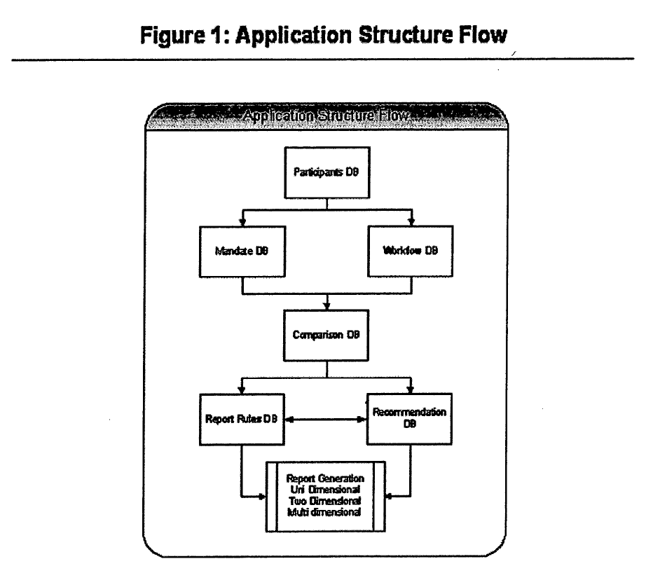

FIG. 1 shows how the six core databases interact with one another. Data regarding Participants is manually or electronically entered into the Participants database. Data regarding Corporate Events is manually or electronically entered into the Corporate Events database. Data regarding fund Mandates is manually or electronically entered into the Mandates database. Data regarding Workflow is manually or electronically entered into the Workflow database. The algorithms contained in the Comparison database then act upon the data in the Participants, Corporate Events, Mandates and Workflow databases to yield a set of data that can be acted upon by the Report rules database. The report rules database then creates a predefined or a chosen-on-the-fly set of reports that may be in the form of tables, two or three dimensional graphs or multidimensional situational awareness environments. These reports are accompanied by a set of summary findings and comments that are elicited from the Findings and Comments database based upon the specific context of the results reported.

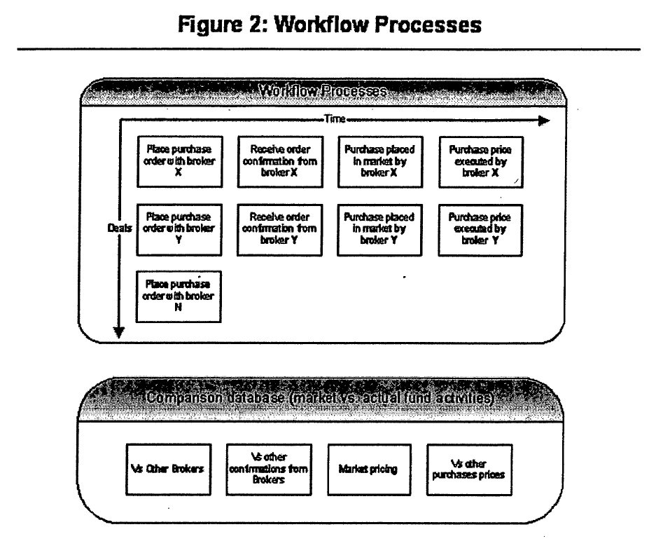

FIG. 2 shows the workflow process that the application will track in real time or ex post facto. This workflow process tracks the event—buy, sell, hold (did not sell financial instruments), no action (did not purchase financial instruments) and its associated date and time. These events and times are compared by the Comparison database with market events and pricing moves with respect that particular financial instrument.

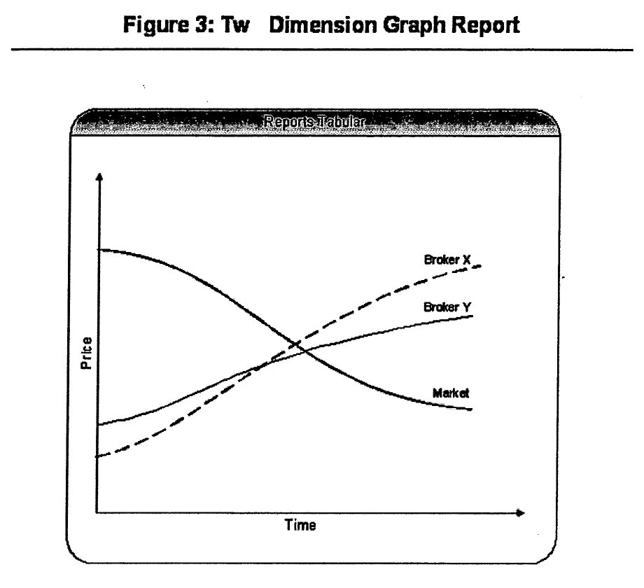

FIG. 3 shows a sample two dimensional graph report illustrating the comparisons between prices paid by two brokers for a specified financial instrument against the highest and lowest market prices on the trading days of that instrument as a function of time and volumes traded. One can see in this example that there is a variance between the prices that both brokers paid and the market price for the particular financial instrument over the measured time period. Furthermore it can be seen that broker x consistently traded at the upper end of the market price while broker y traded at the lower end of the price range, suggesting that further investigation into this broker's behavior and motivations is warranted.

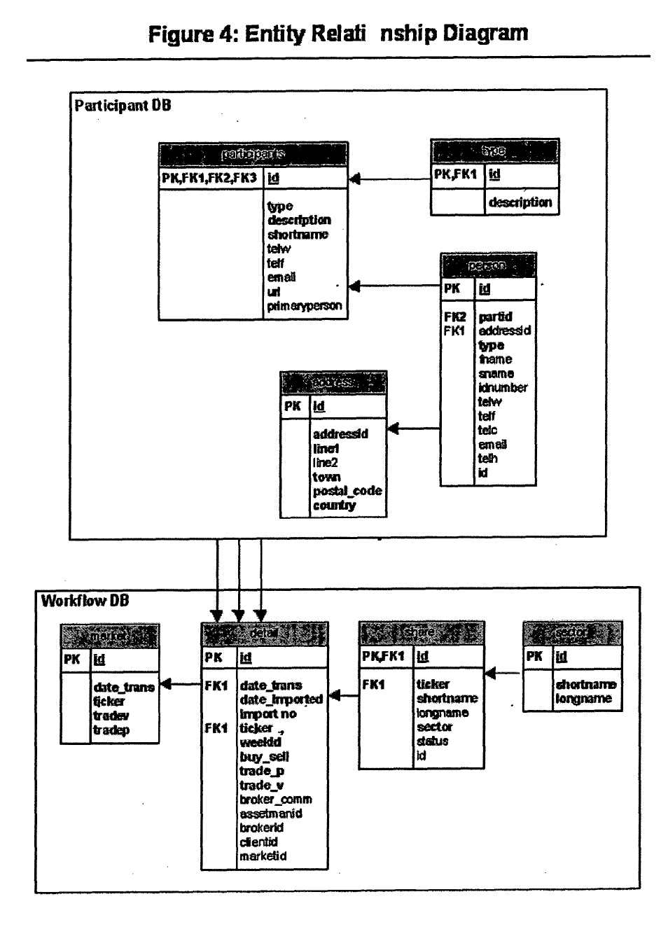

FIG. 4 shows the critical interrelationships between the various classes of participants. Here we see the how the application tracks the workflow of the principal (buyers and sellers of financial instruments) participants entrusted with carrying out the instructions of fund managers at the behest of the Trustees or Overseers of a particular fund. Participant buyers and sellers of financial instruments are tracked against the time, volume and price of of financial instruments bought or sold. Their trading activities, or lack thereof are then compared directly with buy, sell and price actions in the entire marketplace or by other principal participants in the same firm, same sector or same fund class, among others.

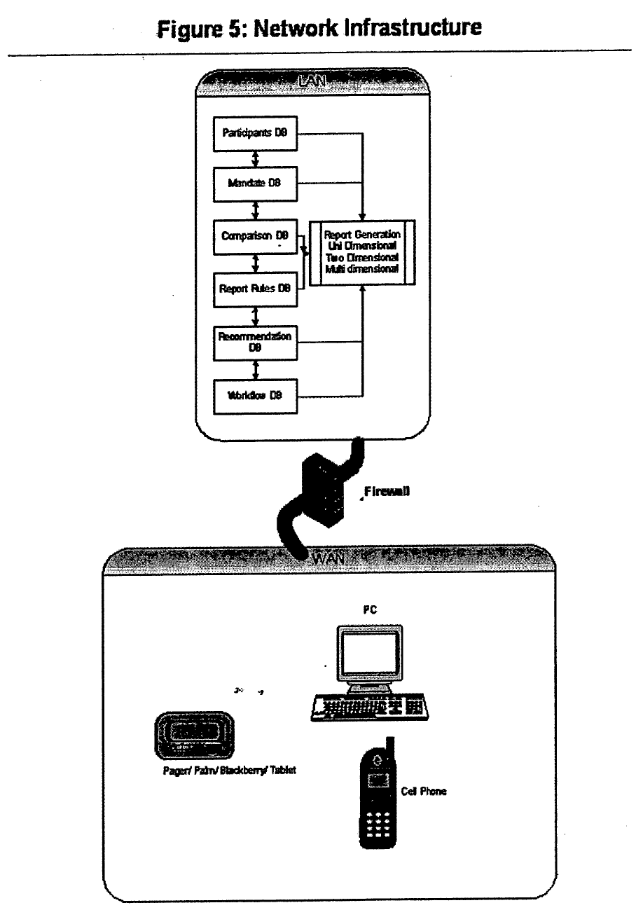

FIG. 5 shows how data will be drawn into and extracted from the application via the internet, World Wide Web, Local area network, and Wide area network in a highly secure, secure socket layer encrypted manner

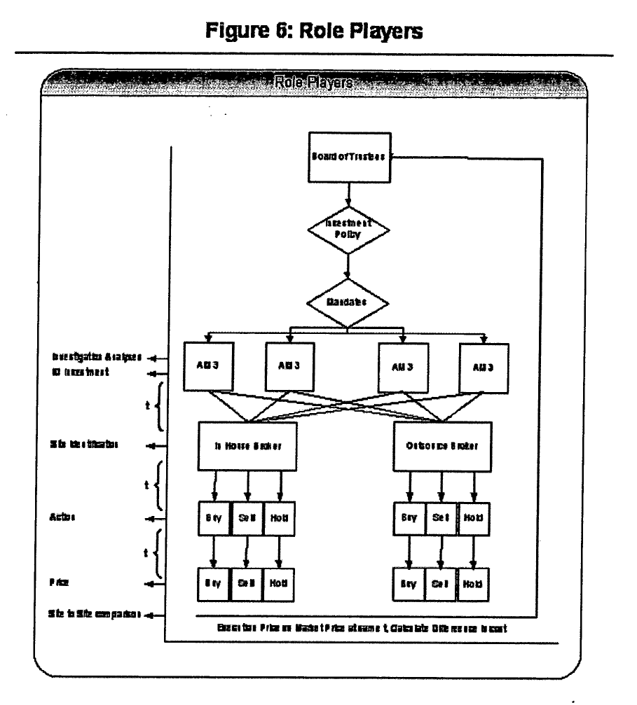

FIG. 6 shows a schematic overview of how the different role players or investment service providers interrelate in the investment process. It also describes the flow of information through a typical purchase; buy of hold decision and the feedback loop to the board of trustees.

Conclusion, Ramifications, and Scope

The invention allows regulators, overseers, trustees and investors to monitor all transactions executed in the investment process. The system is programmable to allow for tailormade parameters and tolerances depending on the clients needs The invention also is also capeable of alerting the client via E-mail or SMS of anomalies, variances or transgressions allowing for timeous response. The invention also afford the client the opportunity to objectively compare the actions of fund managers, brokers and other investment entities (agents) with mandates specified by the client in a way that affords unprecedented insight into the true costs of the transactions to the client. In addition, the reports will show the recommendations about which agents have performed the best according to multiple performance ratings. In short, a tremendous amount of research and analysis legwork across multiple sources is completed for the client and presented in an easy-to-read, highly understandable format that is conducive to incisive action to optimize returns on investment.

While the above description contains many specificities, these should not be construed as limitations on the scope of the invention, but rather as an exemplification of one preferred embodiment. For example, there are several specific areas where the invention could be changed applied so as to be even more useful to a user by a practitioner skilled in the art and this invention incorporates the same within its scope and domain.

1. A programmable automated data processing and response system capable of monitoring/tracking and analyzing of individual or multiple events in the workflow of one or all or a combination of any of the asset management role players/service providers and their respective roles, tasks and obligations in such away that it can expeditiously detect and report anomalies variances and transgressions directly and independently without human intervention if necessary, comprising:
a) a general purpose computer with a computer memory encoded with executable instructions representing a computer program;
b) at least one data storing means accessible by said computer program;
c) a Participants data set stored in said data storage means, said Participants data set comprised of a plurality of Participants capsules from a plurality of sources, each said Participants capsule comprised of the following elements regarding participants in the investment process:
i) type—trustee, overseer, supervisor, fund/asset manager, broker, auditor, actuary, advisor, consultant, principal officer;
ii) unique personal identifier—ID number;
iii) brokerage license;
iv) telephone number—land;
v) telephone number—mobile;
vi) facsimile number;
vii) email address;
viii) internet univeral resource locator (URL);
ix) street address;
x) town;
xi) postal code;
xii) country;
xiii) time zone;
xiv) principal bourse;
xv) secondary bourse;
d) a Corporate Events data set stored in said data storage means, said Corporate Events data set comprised of a plurality of Corporate Events capsules from a plurality of sources, each said Corporate Events capsule comprised of:
xvi) time, date and type of cautionary warnings as issued by a variety of sources that pertain to the market conditions and impact upon decisions to buy or sell individual or sectoral financial instruments;
xvii) time, date and type of proxy voting activities;
xviii) time, date and type of dividends announcements and issuance;
e) a Mandate data set stored in said data storage means, said mandate data set comprised of a plurality of mandate capsules from a plurality of sources, each said mandate capsule comprised of:
i) the rules for acquisition and handling of each type of investment item. These shall include rules derived from specific investment mandates, fund actuaries, consultants, investment managers, investment strategy policies, benchmarking standards and asset mix policy documents;
ii) the algorithms for processing data extracted from the workflow of the entity or trader/stockbroker entrusted with carrying out said mandate;
f). a workflow data set stored in said data storage means, said workflow data set comprised of a plurality of workflow capsules from a plurality of sources, each said workflow capsule comprised of:
i) the steps in the workflow of the broker/trader/investment entity responsible for executing the investment mandates of a specific client;
ii) the date and time of execution of individual or multiple trading activities by a particular broker/trader/investment entity; wherein such activities shall include but not be limited to buying, selling, holding stock, bonds or any other financial instruments, changing to alternate sources of stocks and bonds or any other financial instruments;
g) a comparison database stored in said data storage means, said comparison database comprised of a plurality of comparison data from a plurality of sources, each said comparison data elements comprised of:
i) the calculated delta or variance between the mandate data capsule for each specific investment activity and the actual workflow data acquired by the application;
h) a report rules data set stored in said data storage means, said report rules data set comprised of a plurality of report capsules from a plurality of sources, each said report capsule comprised of:
i) a one-dimensional, two-dimensional or multidimensional representation of the variances calculated by the comparison database;
ii) a Findings and Comments data set stored in said data storage means, said recommendation data set comprised of a plurality of Findings and Comments capsules, each said Findings and Comments capsule:
iii) wherein a summary of the original Findings and Comments is a conclusion in the form of a phrase, grade, code or symbol that suggests a sentiment or a degree of positive, negative, or neutral action toward the item, and
iv) a hierarchy of sources of the Findings and Comments about the item are presented with references to the mandate/s that apply (extracted from the mandate database), the workflow items that are involved (extracted from workflow database), where said hierarchy of sources of the original Findings and Comments about the item is comprised of the source of the heuristics and rationale associated with the recommendation about the item; wherein the Findings and Comments will take the form of a bottom line word or phrase that, with respect to an element such as a stock and conveys various attributes such as advice, praise, caution, warning, or commendation that is either stated or implied by the results of the variance and other analyses performed by the comparison database and displayed as a function of the results rules database.

2. A computer system that facilitates investigation into the efficiency and cost effectiveness of investing behavior by tracking the actions of entities and individuals involved in the buying, selling and management of financial instruments actions at every key step in the process of portfolio management.

3. A system that permits direct dissection and determination of the direct and indirect costs of of executing investment ideas. These costs are tracked by direct calculation of differences in expected versus achieved pricing for financial instruments.

4. A process that is encapsulated within a computer program that enables sequential documentation and tracking of the times and events in the process whereby investments ideas are acted upon and transformed into implemented actions for a designated portfolio.

5. A process that facilitates the oversight of the investment management process in a way that empowers an overseers to fulfill their fiduciary responsibilities.
